(19) United States
(12) Patent Application Publication
(10) Pub. No.: US 2021/0016313 A1
(43) Pub. Date: Jan. 21, 2021

(54) BEE'S WAX FRAME/FOUNDATION DIPPING STATION

(71) Applicant: Michael J. Jenkins, Foristell, MO (US)

(72) Inventor: Michael J. Jenkins, Foristell, MO (US)

(21) Appl. No.: 16/931,691

(22) Filed: Jul. 17, 2020

Related U.S. Application Data
(60) Provisional application No. 62/876,150, filed on Jul. 19, 2019.

(51) Int. Cl. B05C 3/00; B05D 1/18; A01K 51/00

(52) U.S. Cl. CPC B05C 3/005; A01K 51/00; B05D 1/18

(57) ABSTRACT

A dipping station is provided for coating bee hive frame members with a coating of wax. The dipping station comprises a housing having a reservoir for receiving a supply of melted wax. The reservoir approximates the dimension of a frame member. The dipping station is provided with a heating element to melt the wax placed in the reservoir. Water is added to the reservoir to avoid overheating the wax. Individual frame members are dipped into the reservoir containing the melted wax whereby they are coated with melted wax as they are dipped into and removed from the reservoir.

### RELATED APPLICATIONS

The present U.S. non-provisional patent application is related to and claims priority benefit to an earlier-filed provisional patent application titled Bee's Wax Frame/Foundation Dipping Station, Ser. No. 62/876,150, filed Jul. 19, 2019. The identified earlier-filed application is hereby incorporated by reference into the present application as though fully set forth herein.

### BACKGROUND OF THE INVENTION

The invention relates to beekeeping and to the maintenance of man-made hives. Beekeepers raise bees in hives in which honey is produced. A common type hive is the Langstroth beehive which comprises a housing structure that provides for an arrangement of a plurality of removable frames on which the bees can grow honeycomb. The frames are contained in box structures, called supers, which can be stacked upon each other to form the overall hive structure. There are typically 8 to 10 frames per super. The frames can be removed from the beehive at appropriate times so that the honey may be harvested from the honeycomb that the bees build on the frames.

The beehive frames provide the substrate on which the bees produce honey. Each frame provides a thin planar surface on which the bees build their honeycomb. To provide an initial building substrate for the bees to construct their honeycomb, it is useful to apply a layer of wax on which to encourage the bees to start building their honeycomb.

Applying the wax to the frame surface can be a messy, inefficient job. In order to distribute the wax, it must be first melted down into a liquid form. Typical means of applying the melted liquid wax on to the frame surface include applying by brush or roller or by spraying on with appropriate equipment. However, each such method is inefficient and wasteful, and does not deposit the wax on the surface in a nice even coating.

### SUMMARY OF THE INVENTION

The present invention provides a dipping station by which to apply an even coating of wax to individual frames of a beehive. The dipping station comprises a housing having a reservoir for receiving a supply of wax. The dipping station employs a heating source to melt the wax to a liquid state. The wax reservoir is configured in a dimension that approximates the shape and dimension of the beehive frame to loosely receive the frame but to avoid excess interior area. By limiting the interior area to that approximating the size and dimension of the beehive frame, wasting of wax can be avoided.

In using the dipping station, a supply of wax is placed in the dipping station reservoir. At normal room temperature, the wax is a solid and comes in sheet or block form. Bees wax has a melting point of about 147 degrees Fahrenheit. The supply of wax is heated in the reservoir to a temperature above 147 degrees. Water is placed in the reservoir to prevent the wax from overheating and scorching. Optimally, the wax should be brought to a temperature of about 165 degrees so that the wax maintains adequate fluidity, yet still maintains a sufficient viscosity to promote adherence to the surface of the frames when introduced into the reservoir.

When the wax is melted to a satisfactory state, the frames are prepared for the dipping process. The frame is introduced into the reservoir such that its entire planar surface is brought into contact with the melted wax. The wax adheres to the frame's planar surface to provide an even coating of melted wax. The frame is withdrawn from the reservoir and allowed to cool. Upon cooling, the wax solidifies to provide a uniform even surface of wax on the frame surface.

The dipping station housing can be configured, if desired, to have a dimension that can simultaneously receive multiple frames for dipping for the wax coating. Alternatively, multiple reservoirs can be provided so that multiple frames can be dipped. The housing can provide a chamber below the reservoir for receiving a heat source. The heat source can be an externally provided heating element.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a perspective view of a beehive.

FIG. 2 is a perspective view showing the interior of a beehive super frame with the wax frames removed.

FIG. 3 is a perspective view showing the interior of a beehive super frame with wax frames in place.

FIG. 4 is a perspective view of the dipping station.

FIG. 5 is a top plan view of the dipping station.

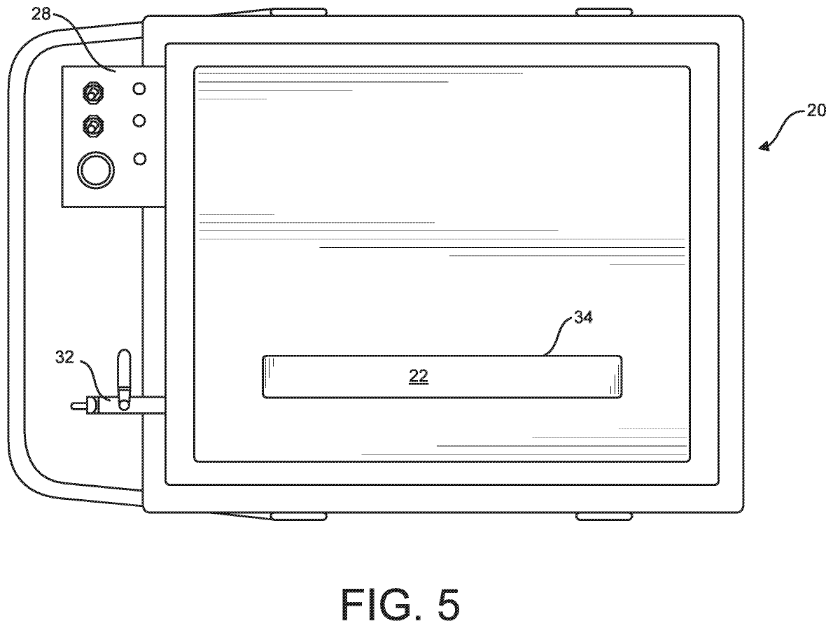

FIG. 6 is a cross-sectional view in side elevation of the dipping station.

FIG. 7 is a view in side elevation from the side of the dipping station.

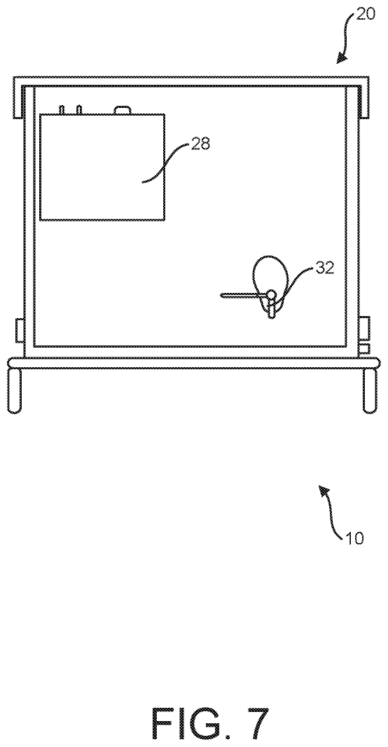

FIG. 8 is a perspective view of heating elements placed below the wax dipping reservoirs.

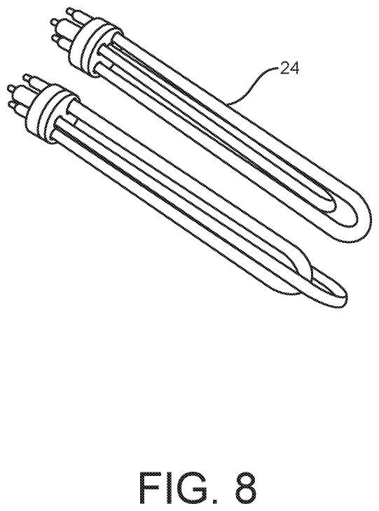

FIG. 9 is a perspective view of a wax frame.

FIG. 10 is a cross-sectional view in side elevation of the dipping station.

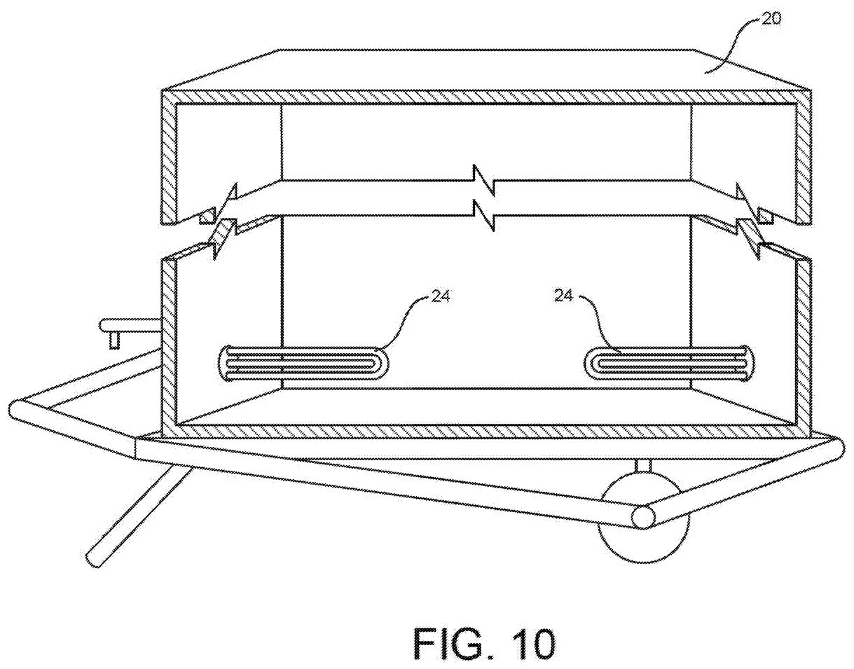

FIG. 11 is a perspective view from the front of the dipping station showing a wax frame prepared for insertion into the dipping station.

FIG. 12 is a perspective view from the front of the dipping station showing a wax frame partially inserted into the dipping station.

FIG. 13 is a perspective view from the front of the dipping station showing a wax frame fully inserted into the dipping station.

FIG. 14 is a cross-sectional view in side elevation from the front of the dipping station showing a wax frame fully inserted into the dipping station.

FIG. 15 is a perspective view from the front of the dipping station showing a wax frame being removed from the dipping station.

FIG. 16 is a diagram of the circuitry for the heating controls.

### DETAILED DESCRIPTION OF THE INVENTION

With reference to the drawings figures, a dipping station for coating wax frames for use in a beehive is herein described, shown, and otherwise disclosed in accordance with various embodiments, including a preferred embodiment, of the present invention.

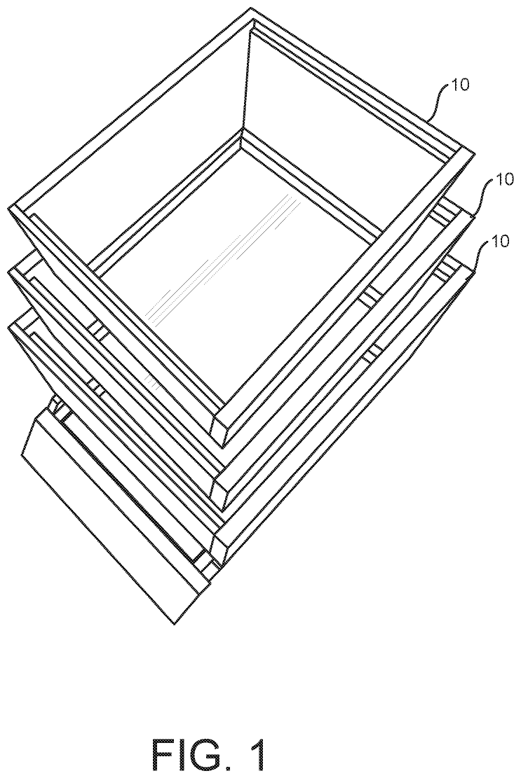

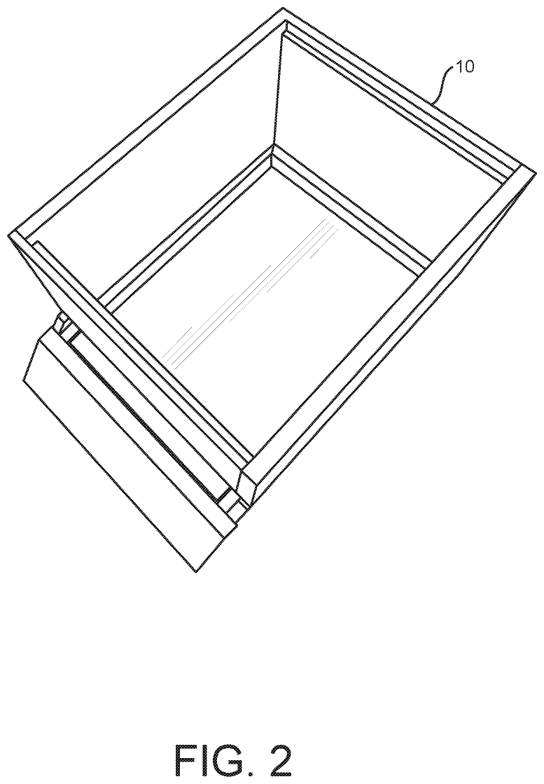

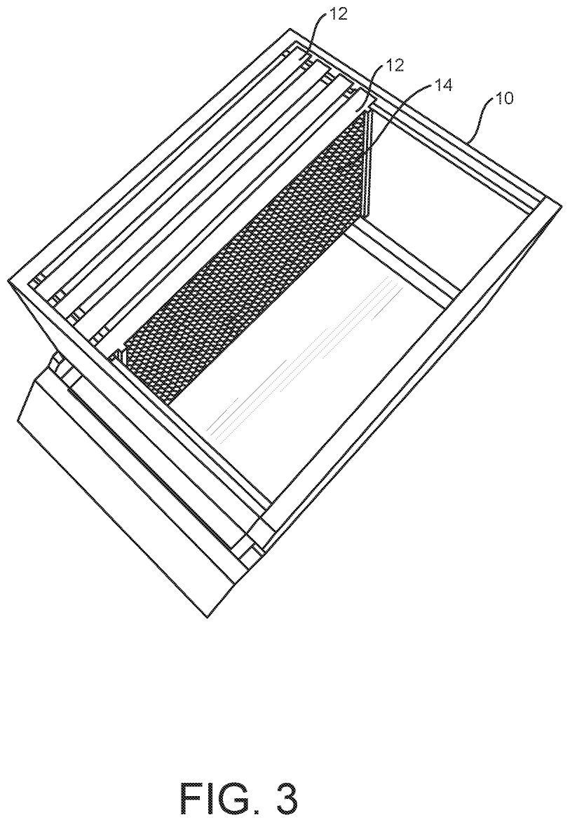

A typical bee hive is constructed of a housing having a number of vertically stacked boxes that support individual frames. A typical box, called a super, is shown in FIGS. 1 and 2 as reference number 10. Several such super boxes 10 are stacked upon each other within the beehive (not itself shown). A typical frame 12 is shown in FIG. 3. Each frame 12 has a planar surface 14 on which the bees build their honeycomb. It is on that planar surface that a layer of wax is applied to encourage bees on which to build their honeycomb. A plurality of frames are supported within the super box as shown in FIG. 3.

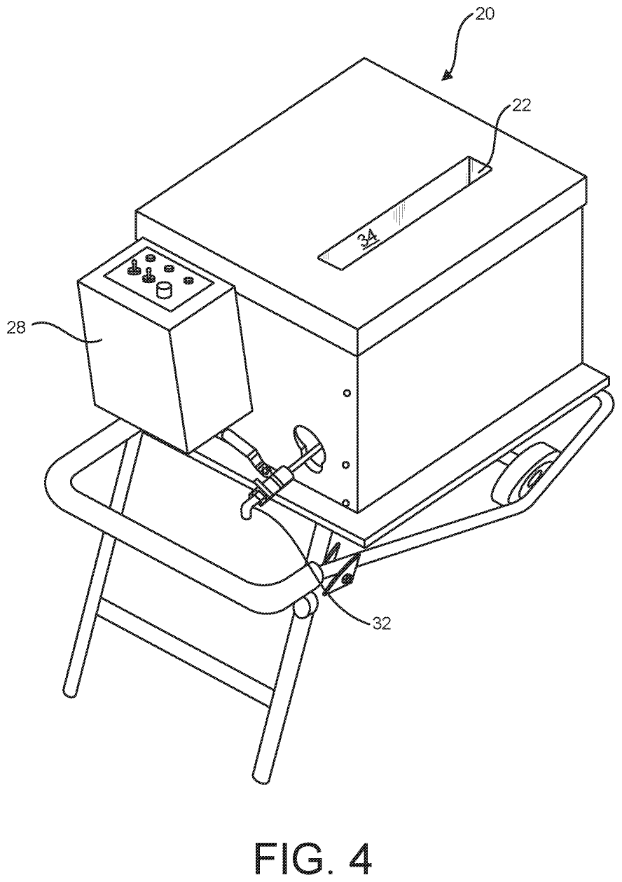

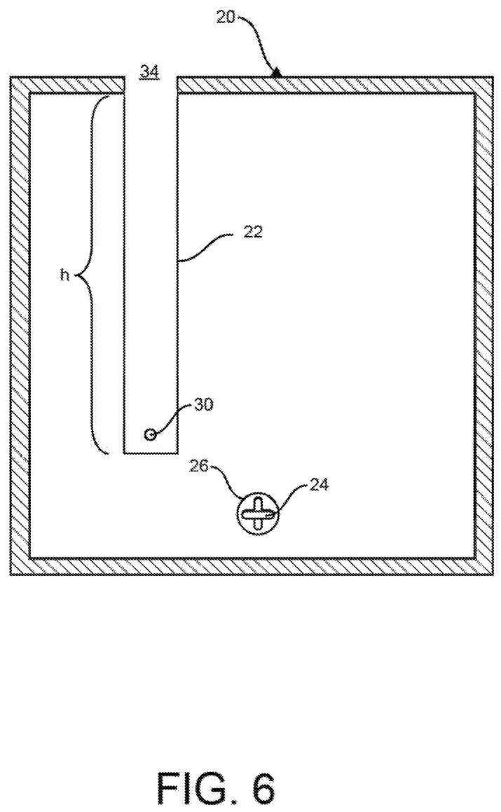

An embodiment of the dipping station of the present invention is shown schematically in FIG. 4 and is shown generally by the reference number 20. Dipping station 20 comprises a housing that is generally hollow. The overall dimensions of the dipping station housing is about 28 inches long, 20 inches wide with a height of about 16 inches. A reservoir 22 is provided in the dipping station housing. Reservoir 22 can be a separately installed container that extends downwardly into the dipping station housing. Reservoir 22 is open at the top of dipping station housing 20 but can be provided with a cover (not shown) when the dipping station is not in use. Reservoir 22 can be provided with a drainage outlet 30 towards its bottom as shown in FIG. 6 which can be provided with drainage pipe 32 that extends out of the dipping station housing 20 as shown in FIG. 4. The placement of reservoir 22 can be near the edge of dipping station housing 20 for ease of access by the user during the dipping process and to provide room at the top of dipping station 20 as a cooling off area for the freshly dipped wax frames.

Reservoir 22 is configured to have a dimension to receive the rectangular shape of the bees wax frame 12. A typical frame 12 has a top edge of about 19 inches in length and a depth edge of about 6 inches. The top opening 34 of reservoir 22 has a length slightly greater than the edge of the frame so that the frame can be received therein. Frame 12 typically has a wood framework around planar surface 14, and planar surface 14 can be removed from the wood framework such that only planar surface 14 needs to be dipped into reservoir 22. The dipping station reservoir has a height h of about 15 inches as shown in FIG. 6. The optimal width of the top opening 34 of reservoir 22 is about two inches to accommodate a single wax frame for dipping. This width helps conserve the amount of wax used in the process and enhances heating efficiency, but reservoir 22 may optionally be made wider to accommodate multiple wax frames for simultaneous dipping. There exist other wax frame types having different dimensions and the dipping station reservoir can be configured to receive such different dimensions within the scope and teaching of the invention.

A heating element 24 is provided within dipping station 20 towards a lower end of reservoir 22 for melting wax as shown in FIG. 6. The heating element can be a 12 volt 600 watt water heater element for example. The dipping station can be configured to receive the heating element in a separate compartment from the reservoir to avoid direct contact with the melted wax. For example, a separate compartment 26 may be disposed within dipping station 20 in near proximity to reservoir 22. A control box 28 for controlling the temperature of heating element 24 may be attached to dipping station 20 as shown in FIG. 4 for operable connection with heating element 24.

In the operation of the dipping station, a supply of wax is placed inside reservoir 22 for melting. Optimally, about 6 to 8 pounds is used for the capacity of reservoir 22 having the internal dimensions described herein, but can vary according to operating conditions. Water is added to the reservoir which provides a couple of benefits. The water helps keep the wax from overheating and becoming scorched during the heating process. Additionally, the water contributes to filling up the space in the reservoir so less wax needs to be used. The water also helps to separate foreign debris from the wax. Wax is lighter than water, so the melted wax will rise above the level of the water in reservoir 22. This enables less overall wax to be used because the dipped frame will encounter and be coated with the melted wax at the upper layer when it emerges from the dipping process, so the entire reservoir need not be filled with wax.

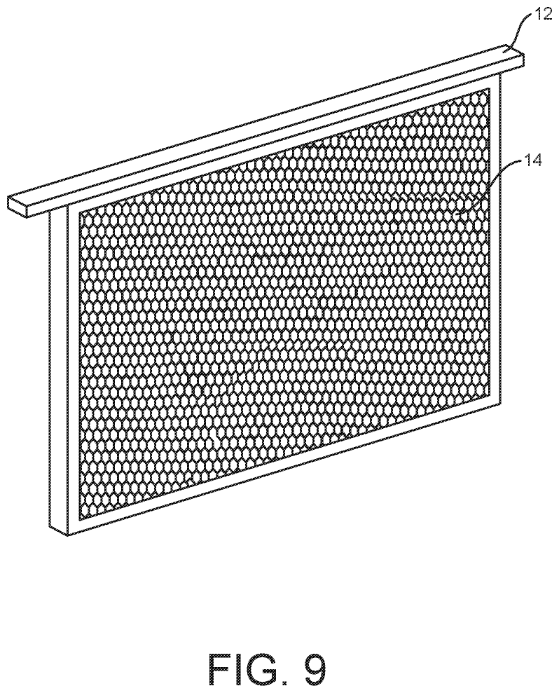

Prior to beginning the dipping process, the heating element 24 is brought to a temperature within the range of 147 degrees to 185 degrees, with the optimum temperature being 165 degrees. As the temperature increases, the layer of melted wax will rise above the level of the water within the reservoir. Once the wax is heated to an optimum temperature to bring it to a liquid consistency, the frames are dipped into the reservoir whereby their planar surfaces are coated with wax. FIG. 9 shows an individual frame 12 in which planar surface 14 is contained, generally by slots within the interior edges of the frame perimeter. The planar surface 14 is separable from the frame 12 so the planar surface 14 can first be removed from frame 12 prior to dipping if desired.

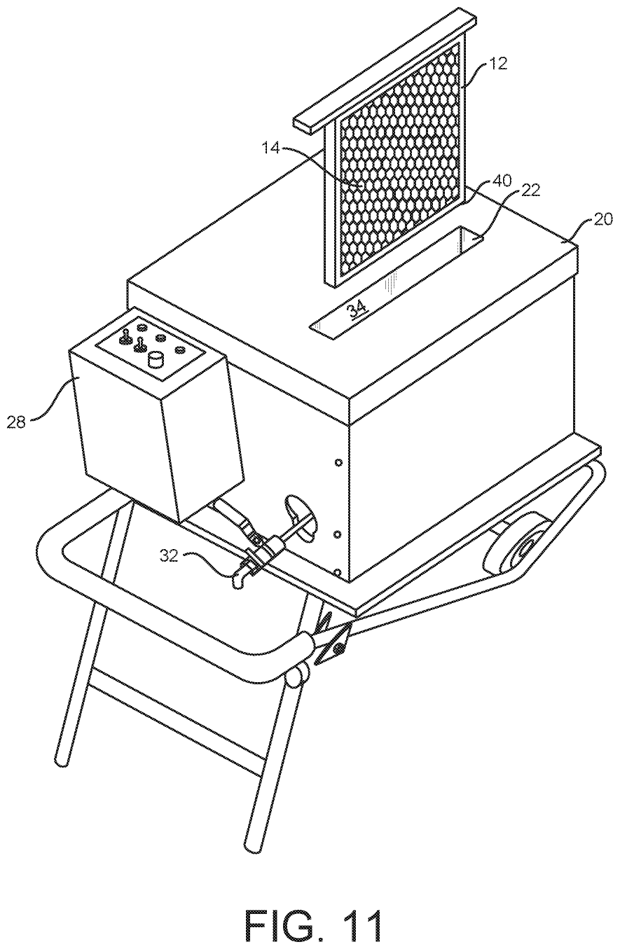

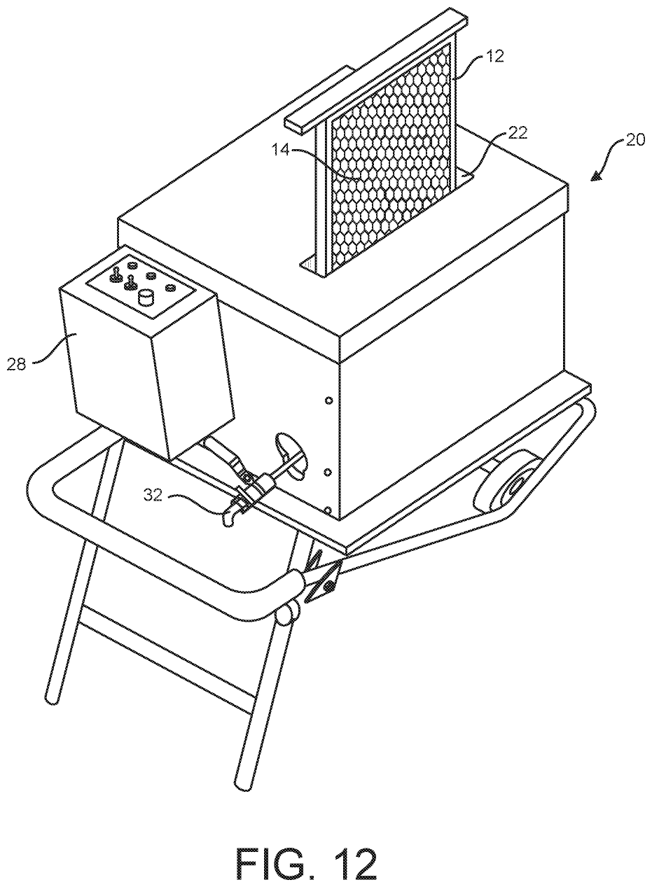

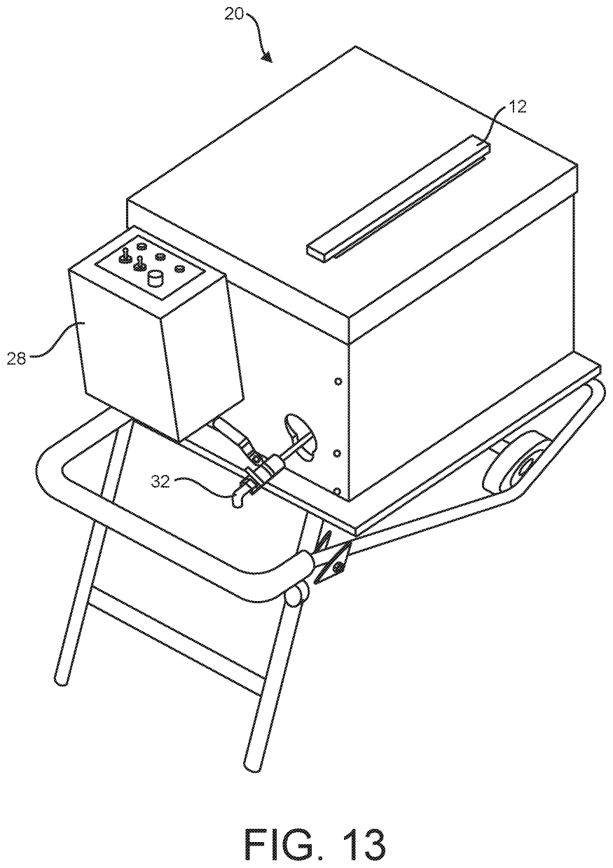

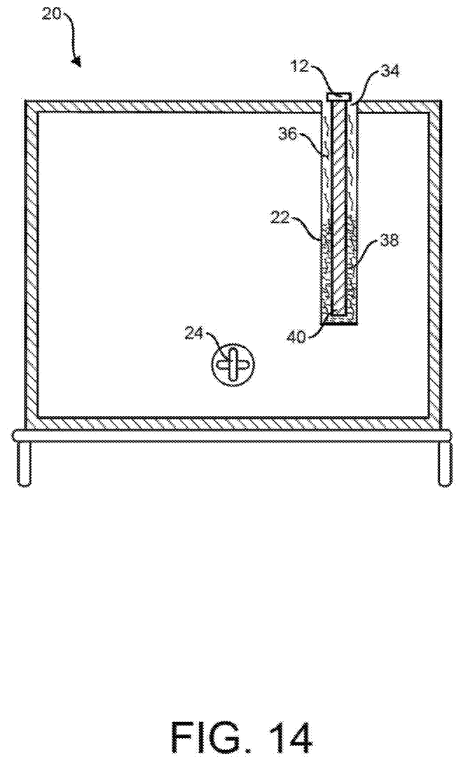

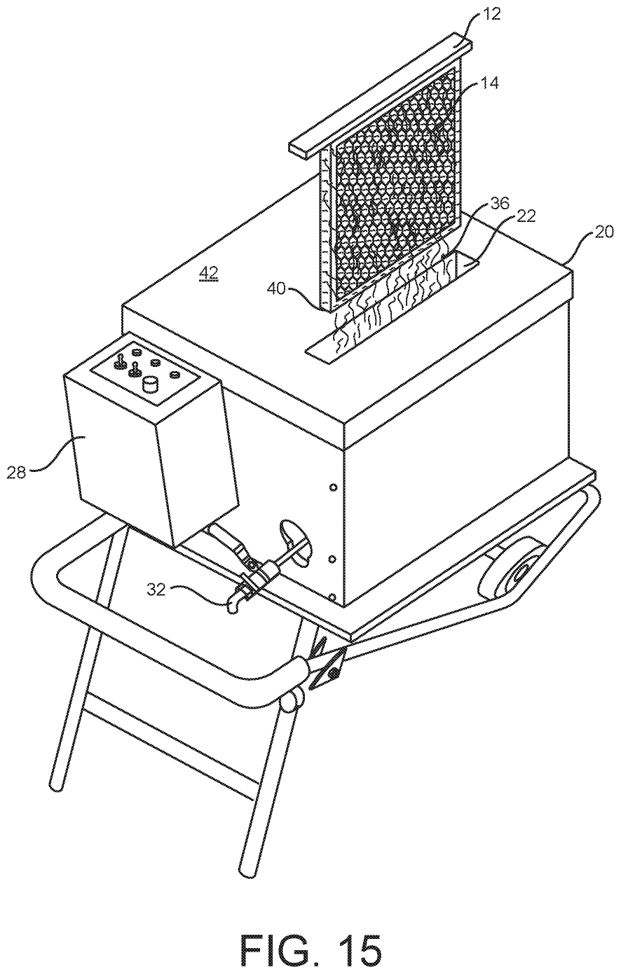

FIG. 11 shows frame 12 positioned above dipping station 20 ready for insertion into reservoir 22 to be coated with melted wax. In FIG. 12, frame 12 is inserted into reservoir 22. FIGS. 13 and 14 show frame 12 fully inserted into reservoir 22 where it becomes coated by melted wax 36. The layer of melted wax 36 sits on top of the water layer 38. Although lower edge 40 of frame 12 passes into the water layer 38 on full insertion of frame 12 into reservoir 22, it passes through melted wax layer 36 upon withdrawal of frame 12 from reservoir 22 as shown in FIG. 15 whereby the entire planar surface 14 gets coated by the wax.

As the frame 12 is removed from reservoir 22, it takes about 5 to 6 seconds for the wax on planar surface 14 to solidify. The dipping process leaves an even layer of wax on the frame surface. As multiple frames are coated with wax, they can be staged on area 42 on top of dipping station 20 for further cooling until ready for placement back into the super boxes 10 for use with the beehive.

The dipping station provides a safe and efficient way to apply a uniform and even coating of wax to wax frames for use in bee hives. Given the safety hazards that can be caused in heating wax using an open flame, confining the melted wax to the confined reservoir 22 minimizes splattering of hot wax that can cause burns to the user. After a dipping session, the water in reservoir 22 can be drained from drainage outlet 30 through drainage pipe 32. The wax can be easily recovered after it solidifies, or can be kept in reservoir 22 until the next dipping session.

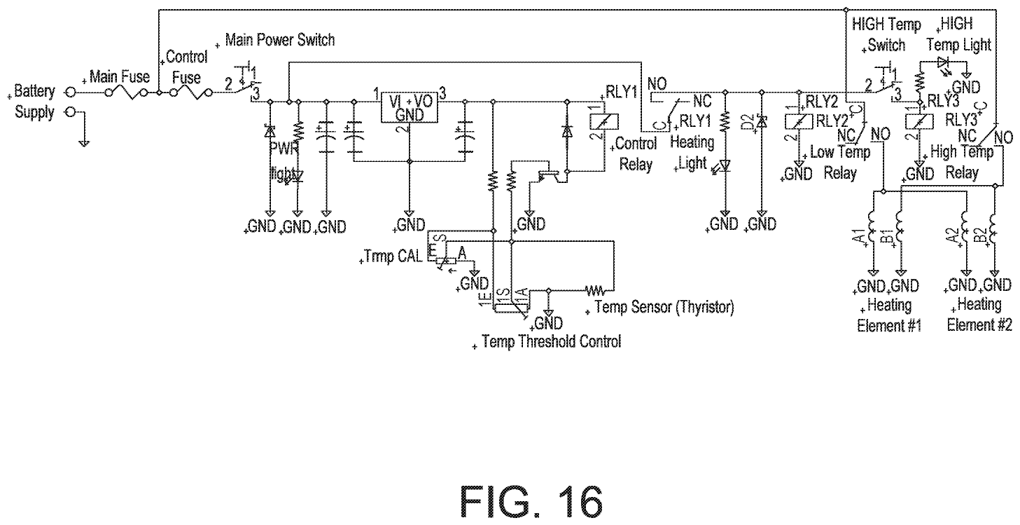

An embodiment of the heating unit comprises using the power from a vehicle battery. For example, a 12 volt battery from a truck can be hooked up through a DC connection. The connector can be an Anderson plug SMH SY connector to hook up the truck battery to the control panel for the heater 28 via a 12 volt bus bar. The contacts equally control 300 watts to the heating element 24. Circuitry in the control panel sets the on/off functions to the heating element. A thermostat is provided to measure the temperature of the reservoir 22. A limiting heating feature avoids thermal runaway to a top temperature of 212 degrees. The temperature control also varies by +/−5 degrees, to have a smoother heating. If the temperature is set to 160 degrees, once the temperature drops to 159, the heaters turn on until the temperature reaches 165 degrees, then shuts off. FIG. 16 displays the circuitry diagram for the heating regulator.

Although the invention has been disclosed with reference to various particular embodiments, it is understood that equivalents may be employed and substitutions made herein without departing from the scope of the invention as recited in the claims.

1. A dipping station for applying a coating of wax to an individual frame member on which bees produce honey in a beehive, the dipping station comprising a housing having a reservoir for storing melted wax, the reservoir having a rectangular internal dimension positioned in a vertical orientation, the reservoir having an overall internal dimension for receiving the frame member whereby a frame member dipped into the reservoir is coated with the melted wax contained in the reservoir.

2. The dipping station of claim 1 in which the reservoir has an internal dimension approximating the overall dimension of the frame member.

3. The dipping station of claim 1 in which a heating element is provided in the dipping station housing in proximity to the reservoir to melt wax placed in the reservoir.

4. The dipping station of claim 3 in which the heating element is adapted for receiving power from a battery, a thermostat being provided for measuring the temperature of the heating element, a control panel being provided for adjusting the temperature of the heating element.

5. The dipping station of claim 1 in which the reservoir has a drainage port whereby liquid may be drained from the reservoir.

6. A method for applying a coating of wax to a frame member on which bees produce honey in a beehive, comprising the steps of:
Providing a dipping station housing having a reservoir with an opening at a top surface of the housing;
Configuring an interior dimension of the reservoir to receive the frame member entirely within the reservoir;
Providing a supply of wax in the reservoir;
Melting the supply of wax to a liquid consistency;
Dipping the frame member into the reservoir whereby a surface of the frame member becomes coated with a layer of melted wax; and
Removing the wax-coated frame member from the reservoir to cool whereby the wax solidifies on the surface of the frame member.

7. The method of claim 6 in which a heat source is positioned in the dipping station housing in proximity to the reservoir for melting the wax in place within the reservoir.

8. The method of claim 6 in which a supply of water is added to the reservoir whereby a layer of the melted wax is displaced above a layer of the water, whereby an amount of the supply of wax needed for coating the frame member is reduced.

9. The method of claim 6 in which the interior dimension of the reservoir is configured to approximate the dimension of the frame.

10. The method of claim 8 in which the reservoir is provided with a drainage port whereby the water may be drained from the reservoir.
